(19) United States
(12) Patent Application Publication
(10) Pub. No.: US 2005/0271100 A1
(43) Pub. Date: Dec. 8, 2005

(54) System and method for controlling optical sources, such as laser diodes, and computer program product therefor

(76) Inventors: Keith Everett, Bury St Edmunds (GB); Clive John Hook, Newmarket (GB); Neil Stafford, Debenham (GB); Luke Hitchin, Singapore (SG)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/133,059

(22) Filed: May 19, 2005

(30) Foreign Application Priority Data
Jun. 4, 2004 (GB) 0412509.2
Jun. 18, 2004 (EP) 04102805.1

(51) Int. Cl. H01S 3/00

(52) U.S. Cl. 372/38.02; 372/38.07

(57) ABSTRACT

A system for controlling operation of an optical source, such as a laser diode for optical communications, by controlling a bias current and a modulation current supplied thereto. With the source there are associated sensors for sensing the radiation generated and the temperature of the optical source to derive therefrom a first signal indicative of the power of the source radiation and a second signal indicative of the source temperature. The system includes a control circuit for controlling the bias current of the source as a function of the difference between the first signal indicative of the power of the radiation and a predetermined optical power set point signal, while generating a signal indicative of said bias current, and a driver device including an output for producing the predetermined optical power set point signal, a modelling block for generating a current threshold value as a function of the second signal indicative of the source temperature, and a comparator fed with the signal indicative of said bias current and the threshold current to produce the source modulation current as a function of said difference. Preferably the driver device and at least a part of the control circuit are implemented in the form of a programmable system on a chip (“psoc”).

Commercial applications of optical sources such as e.g. laser diodes for WDM (Wavelength Division Multiplex) require real time automatic control of a number of operating parameters such as e.g. the wavelength emitted, the optical power and the extinction ratio (ER), that is the ratio between the optical power of a “1” and the optical power of a “0” emitted by the optical source controlled.

The control system(s) must be compact in size in order to be co-packaged with the other components (typically the optical radiation source and the modules currently associated therewith) while avoiding coupling, space and power dissipation problems.

A number of different techniques have been proposed in the art for wavelength and power control of optical sources. These include both analog arrangements, as disclosed e.g. in U.S. Pat. No. 5,825,792, and micro-controller based systems for controlling a laser driver in a transceiver (see e.g. U.S. Pat. No. 5,019,769). Fairly sophisticated wavelength control apparatus is also known e.g. from U.S. Pat. No. 5,438,579 intended to counter temperature variations as the main source of undesired wavelength variations.

Wavelength (and power) control of an optical source such as a laser diode is frequently performed by means of a “wavelength locker” arrangement. A current wavelength locker arrangement includes a wavelength selective optical component and photodiodes to detect any wavelength and power variations in the laser source, a laser driver to bias the laser diode and a thermoelectric element such as a Peltier element for controlling the temperature of the laser diode together with its drive circuit.

The extinction ratio may be controlled by controlling the modulation current required to produce the correct extinction ratio by using a model of the modulation current against the bias current. This approach is adapted to be implemented by means of dedicated integrated circuits (ICs) using the same algorithm but differing in the way the set up is accomplished.

This arrangement may turn out to be unsatisfactory for fast, modern lasers sources. In fact, this approach assumes that the optical power is held constant at all temperatures. With some recent “fast” laser sources an improvement in the eye quality can be obtained by changing the optical power output at different temperatures. This in turn can cause problems in controlling the extinction ratio (ER).

Additionally, a key factor to be taken into account in producing such control systems is flexibility, that is the possibility of adapting the same system to controlling devices with different characteristics (working point, bias current and temperature, requirements in terms of stability, frequency and power, driver response).

The need is thus felt for control systems adapted to be associated with an optical source in a compact arrangement while satisfying a number of basic requirements such as:
the control system must be flexible and cheap,
all the components must be suitable to be mounted on board while admitting only pre-operational initialisation using external apparatus,
board space and component count must be reduced, in order to reduce production cost, and
the system must enable control of the optical source to provide different optical powers at different temperatures.

The object of the present invention is to provide an improved control arrangement fully satisfying the requirements outlined in the foregoing.

According to the present invention, such an object is achieved by means of a system having the features called for in the claims that follow. The invention also relates to a corresponding method and a computer program product, loadable into the memory of a computer (e.g. a digital controller/processor such as e.g. a so-called programmable system on a chip or “psoc”) and comprising software code portions for implementing the system of the invention and/or performing the steps of the method of the invention when that product is run on the controller. As used herein, reference to such a computer program product is intended to be equivalent to reference to a computer-readable medium containing instructions for controlling a computer system to coordinate the performance of the system/method of the invention.

A preferred embodiment of the invention includes programmable driver device implemented on a commercially available device such as a so-called programmable system on a chip or “psoc”. This has a microprocessor core and configurable hardware blocks that can perform analog and digital functions. Being programmable, this allows the control algorithm/function to be changed without changing the surrounding hardware/pcb (printed circuit board) layout.

In a particularly preferred embodiment, the threshold current of the source is modelled against temperature at set up. During operation, the temperature of the laser is measured and the threshold current is obtained from the model. The bias current required to produce the optical power is measured and the difference between the bias current the threshold current calculated. This gives a measure of the slope efficiency of the laser at the operating temperature. By multiplying the bias current−threshold current difference by a constant (according to the extinction ratio required) the required modulation current is obtained.

The system is preferably designed to allow changes in the optical power, particularly with temperature and is best implemented using a microprocessor. The optical power loop would be implemented using standard analog components with the optical power set point being provided by the microprocessor. The bias current and temperature would then be fed into the processor, which would calculate the required modulation current,

The invention will now be described, by way of example only, with reference to the enclosed figures of drawing, wherein:

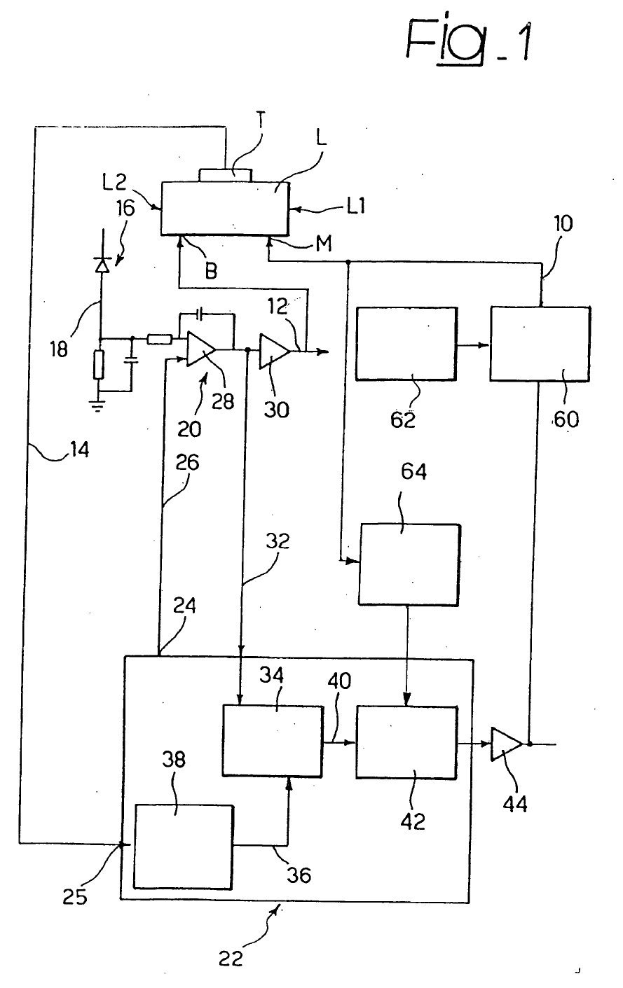

FIG. 1 is a block diagram showing the general layout of a system according to the invention, and

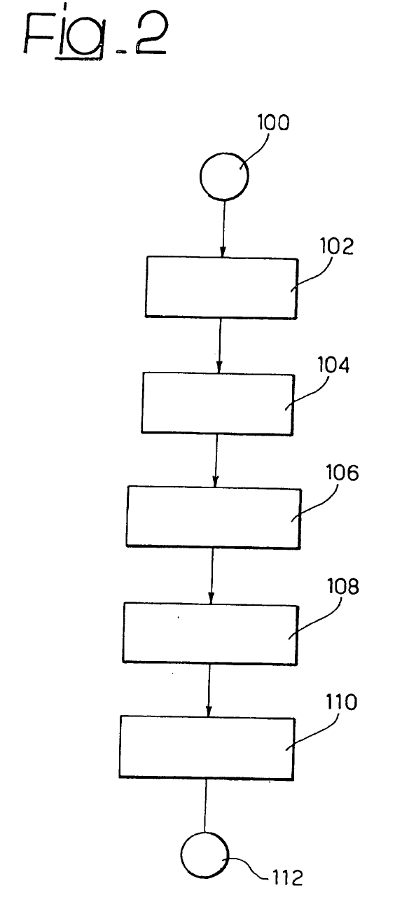

FIG. 2 is a flowchart representative of possible exemplary operation of the system of FIG. 1.

In FIG. 1, reference L denotes an optical source such as a laser diode adapted for use e.g. in a WDM (Wavelength Division Multiplex) fiber-optic transmission system, for instance of the “dense” type (D-WDM).

The laser source L includes a front facet L1 from which the “useful” radiation beam to be injected into a fiber (not shown) is generated. The laser source L also includes a back facet L2 from which optical radiation is derived for control purposes as better detailed in the following.

Operation of the laser source is controlled via two input ports B and M for the bias current and the modulation current, respectively.

All of the foregoing corresponds to a device arrangement and criteria of operation that are well known in the art, thus making it unnecessary to provide a further detailed description herein.

This applies i.a. to the basic principle of generating the high speed, high current modulation current applied to the laser L by combining two components, namely:
a low current, very low frequency signal representing the required modulation current, and
a high speed, low current data signal.

Similarly known is the possibility of associating with the laser source L a temperature sensor T.

Associated with the laser are additional components such as e.g. a thermoelectric element (such as a Peltier element) adapted to control the temperature of the laser junction in order to stabilize or “lock” the emission wavelengths thereof. Emission wavelength “locking” is usually accomplished by detecting the actual emission wavelengths of the laser L, which preferably occurs based on radiation derived from the back facet L2 of the laser. These and other ancillary components typically associated with the laser source L are not shown and will not be described herein as these ancillary components are of no direct momentum for the exemplary arrangement of the invention considered herein.

The arrangement described in detail herein is intended to control the extinction ratio (ER) that is the ratio between the optical power of a “1” and the optical power of a “0” emitted by the laser L via the front facet L1.

More specifically, the control action involves controlling the modulation current as provided over a line 10 to the input port M of the laser while also controlling the bias current provided over a line 12 to the input port B.

Reference numeral 14 designates a line coming down to the temperature sensor T associated with the laser source L and conveying a signal indicative of the temperature of the laser (junction).

Reference 16 designates a photodiode (or an analogous opto-electrical converter) exposed to the radiation (light) from the back facet L2 of the laser L. The photodiode 16 provides over a line 18 a signal indicative of the intensity of the radiation from the back facet of the laser to an analogue bias control circuit designated as a whole by reference numeral 20.

Reference numeral 22 designates as a whole a controller device of the type commercially available under the designation of programmable system on a chip (psoc). This device currently includes a microprocessor core and configurable hardware blocks that can perform analogue and digital functions. Being programmable, such a device is adapted to implement a control algorithm that can be changed without changing the surrounding hardware PCB (Printed Circuit Board) layout.

The device 22 operates as a driver and includes a first output port 24 adapted to provide over a line 26 a signal representative of a desired optical power set point for the source L.

The signal provided over the line 26 is fed to one of the inputs (typically the non-inverting input) of a differential amplifier 28 included in the analog circuit 20.

The other input (typically, the inverting input) of the amplifier 28 is fed with a signal derived (via standard filtering and scaling circuitry) from the line 18 and thus from the photodetector 16.

The output signal from the differential amplifier/stage 28 is fed to a voltage-to-current converter 30 whose output is the bias current signal fed to the bias input port B of the laser L via the line 12.

The arrangement comprised of the photodiode 16 and the circuit 20 implements an analogue feedback loop intended to control the bias current to the laser L at a level adapted to ensure that the optical power from the front facet L1 corresponds to the set point value provided by the driver device 22 over the line 26.

A signal indicative of the bias current input at the bias port B is derived from the circuit 20 over a line 32 that extends towards the driver device 22.

In the exemplary embodiment described herein, the bias current signal on the line 32 is derived from the output of the differential amplifier 28.

Those of skill in the art will promptly appreciate that the specific arrangement shown is a purely exemplary one: a signal representative of the bias current applied to the laser L may in fact be derived at other points of the circuit 20, for instance at the output of the voltage-to-current (transconductance) converter/amplifier 30.

Deriving (“tapping”) the signal on the line 32 at the output of the amplifier 30 is however an advantageous choice as the voltage signal derived thereby is directly adapted for comparison in a comparator block 34 included in the drive device 22.

In the comparator 34 the signal on the line 32, which is representative of the laser bias current, is compared with a signal present on a line 36 and generated by a block 38.

Essentially, the block 38 has the purpose of modelling a threshold current against temperature at set up of the arrangement shown. During operation, the temperature of the laser L is measured (via the sensor T) and a corresponding “model” threshold current value is obtained in the block 38.

Essentially, in the block 38 the laser temperature as sensed by the sensor T and represented by the signal input to the drive device 22 via the input port 25 is used to generate a value representative of a threshold current. In a currently preferred embodiment, modelling involves using a third order polynomial, where only the coefficients are stored. The threshold current is calculated for each measured temperature. The coefficients are derived by plotting the measured threshold current against temperature and searching for the best-fit condition.

The signal on the line 32 is representative of the bias current required to produce a desired value of the optical power.

The signal emitted by the comparator 34 over an output line 40 is thus a signal representative of the difference between the bias current (line 32) and the threshold current calculated (as a function of temperature) in the block 38. Essentially, the difference signal output from the comparator 34 (line 40) gives a measure of the “slope efficiency” of the laser at the operating temperature.

The signal on the line 40 is multiplied by a constant in a multiplier block or module 42 (i.e. a gain factor) included in the driver device 22 to produce, via another voltage-to-current (transconductance) converter/amplifier 44, a current signal adapted to drive the modulation current fed to the laser input port M over the line 10.

The multiplier block or module 42 is programmable in that the value of the multiplier constant can be selectively varied.

As schematically shown in FIG. 1, the output stage of the amplifier 44 has an associated high speed switch in the form of an integrated circuit (IC) located local to the laser source L.

The switch in question either switches the modulation current towards the laser L (line 10, input M, via a driver unit 60 to be better described in the following), hence increasing the laser optical output, or switches it into a dummy load (not shown), giving a lower optical output, thus controlling, in a manner known per se, the extinction ratio (ER).

As indicated in the foregoing, the high speed, high current modulation current applied to the laser L via the modulation port M is comprised of two components, namely a low current, very low frequency signal representing the required modulation current and a high speed, low current data signal.

More in detail, the signal produced by the output of the psoc driver device 22 is a low current, very low frequency (near dc) signal representing the required modulation current. The signal from the driver device 22 is fed into the laser driver circuit 60, which is typically in the form of an integrated circuit or IC. The laser driver 60 takes this signal and combines it with the high speed, low current modulation data produced by a modulation source 62 (of a known type) to produce the actual high speed, high current modulation current used to drive the laser L.

There is a current gain between the actual modulation current and the signal produced by the output of the psoc driver device 22, and this current gain is exposed to undesired variations in that it may vary over temperature.

To overcome this problem, in the arrangement disclosed herein the actual modulation current applied to the laser source L is sensed (measured) using an RF power monitor (again typically in the form of an integrated circuit or IC) 64.

The power monitor 64 provides a near dc voltage signal that is proportional to the high frequency modulation current. This is fed back to the driver device 22 (e.g. towards the multiplier/gain block 42, alternative choices being however evident for those of skill in the art) so that the signal produced by the output of the psoc driver device 22 can be adjusted accordingly. This arrangement is essentially in the form of a modulation current feedback to the driver device 22 so that the output of the driver device 22 is adjusted to give the correct modulation current.

The flow chart of FIG. 2 is exemplary of the basic processing operation performed within the arrangement just described. This operation essentially is coordinated by control logic/software code included (in a manner known per se) in the driver device 22.

Typically, the set of operations or steps represented by the flowchart of FIG. 2 may be repeated between 50 to 100 times per second during operation of the laser L.

After a start step 100, in a step 102 the temperature of the laser L, as represented by the signal present on the line 14 (input 25 to the driver device 22) is measured.

In a step 104, a corresponding value for the threshold current is obtained from the module represented by the block 38.

In a step 106, the bias current value received over the line 32 is measured and in a step 108 the bias current in question and the threshold current value produced by the block 38 are compared to produce the output signal from the comparator 34.

The step 110 represents the multiplication of the output signal from the comparator 34 by a constant in view of transmission to the transconductance amplifier 42.

The end of the sequence of operation described is marked by an end step designated 112.

Those of skill in the art will appreciate that, despite the strictly sequential nature of the flowchart of FIG. 2, at least some of the operations/steps described therein may be performed in parallel.

The driver device 22 is preferably in the form of a programmable system on a chip (psoc), including a microprocessor core and configurable hardware blocks, thus making the device 22 capable of performing both analogue and digital functions. Being programmable, the control principles implemented thereby (for instance the model implemented in the block 38 or the multiplying constant of the block 42) can be changed without having to change the surrounding hardware and PCB layout.

Of course, the principles of the invention remaining the same, the details of construction and the embodiments may widely vary with respect to what has been described and illustrated purely by way of example, without departing from the scope of the present invention as defined by the annexed claims.

This applies i.a. to a number of variants, including but not limited to:
adopting as the controller (i.e. the driver device 22) a type of controller different from a psoc: possible alternatives include but are not limited to e.g. a microprocessor, a micro-controller, a microcomputer or a processing module/function of a digital processing device that supervises operation of the whole arrangement of parts shown in FIG. 1;
different implementations of the bias control circuit 20; for instance, while described herein as a separate analog circuit, the circuit 20 can be implemented partly in psoc form and partly in hardware, thus integrating it at least partly with the driver device 22.

Additionally, it will be appreciated that terms such as “optical”, “light”, “photosensitive”, and the like are used herein with the meaning currently allotted to those terms in fiber and integrated optics, being thus intended to apply to radiation including, in addition to visible light, e.g. also infrared and ultraviolet radiation.

1. A system for controlling operation of an optical source by controlling a bias current and a modulation current supplied thereto, the source having associated sensors for sensing the radiation generated by said optical source and the temperature of said optical source to derive a first signal indicative of the power of said radiation and a second signal indicative of said temperature, the system including:
a control circuit for controlling said bias current as a function of the difference between said first signal indicative of the power of said radiation and a predetermined optical power set point signal, while generating a signal indicative of said bias current, and
a driver device including:
an output for producing said predetermined optical power set point signal,
a modelling block for generating a current threshold value as a function of said second signal indicative of said temperature sensed, and
a comparator fed with said signal indicative of said bias current and said threshold current to produce the difference thereof; said comparator having associated at least one gain factor to produce at least one component of said modulation current as a function of said difference.

2. The system of claim 1, wherein said optical source is a semiconductor laser source.

3. The system of claim 1, further including an analog circuit to produce said bias current as a function of said first signal indicative of the power of said radiation and said predetermined optical power set point signal.

4. The system of claim 3, further including a voltage-to-current converter for generating said bias current as a function of said first signal indicative of the power of said radiation and said predetermined optical power set point signal.

5. The system of claim 1, wherein said driver device has an associated voltage-to-current converter for generating said at least one component of said modulation current as a function of the output of said comparator.

6. The system of claim 5, further including a multiplier block arranged between said comparator and said associated voltage-to-current converter to provide said at least one gain factor.

7. The system of claim 1, wherein said driver device is programmable for selectively varying at least one of:
said predetermined optical power set point signal,
the model implemented in said modelling block for generating said current threshold value as a function of said second signal indicative of said temperature sensed, and
the value of said at least one gain factor associated with said comparator to produce said at least one component of said modulation current as a function of said difference.

8. The system of claim 1, wherein said driver device is a programmable system on a chip.

9. The system of claim 1, wherein the control circuit is at least partly implemented as a programmable system on a chip.

10. A system for controlling operation of an optical source by controlling a modulation current supplied thereto, the system including:
a source driver configured for producing said modulation current for said source as a function of a first, near dc modulation component and a second, high speed, data modulation component, said source driver producing a gain between said first near dc modulation component and said modulation current for said source, wherein said gain is exposed to variations,
a driver device configured for producing said first, near dc modulation component, and
a feedback loop from said modulation current for said source and said driver device to stabilize said modulation current for said source against said variations.

11. The system of claim 10, wherein said feedback loop includes a RF power monitor to sense said modulation current for said source, provide a corresponding sensing signal, and feed said sensing signal back towards said driver device configured for producing said first near dc modulation component.

12. The system of claim 11, wherein said RF power monitor provides a sensing signal proportional to said modulation current for said source.

13. A method of controlling operation of an optical source by controlling a bias current and a modulation current supplied thereto, the method comprising:
sensing the radiation generated by said optical source to derive a first signal indicative of the power of said radiation and a second signal indicative of said temperature,
controlling said bias current as a function of the difference between said first signal indicative of the power of said radiation and a predetermined optical power set point signal, while generating a signal indicative of said bias current, and
providing a driver device configured for:
producing said predetermined optical power set point signal,
generating, based on a model, a current threshold value as a function of said second signal indicative of said temperature sensed,
producing the difference between said signal indicative of said bias current and said threshold current, and
producing via at least one gain factor at least one component of said modulation current as a function of said difference.

14. The method of claim 13, further including selectively varying at least one of:
said predetermined optical power set point signal,
said model used for generating said current threshold value as a function of said second signal indicative of said temperature sensed, and
said at least one gain factor used for producing said at least one component of said modulation current as a function of said difference.

15. The method of claim 13, wherein generating based on a model involves determining a value for said current threshold value for each value of said second signal indicative of said temperature sensed.

16. A computer program product loadable in the memory of at least one computer and including software code portions which cause said computer to perform the function of the driver device of the system of claim 1.

17. A computer program product loadable in the memory of at least one computer and including software code portions for performing at least a part of the method of claim 13.
